(19) United States
(12) Patent Application Publication
(10) Pub. No.: US 2020/0044276 A1
(43) Pub. Date: Feb. 6, 2020

(54) SECONDARY BATTERY

(71) Applicant: Panasonic Intellectual Property Management Co., Ltd., Osaka-shi, Osaka (JP)

(72) Inventors: Yoshinori Sakai, Hyogo (JP); Tomoki Tsuji, Osaka (JP); Masanobu Takeuchi, Tokyo (JP)

(73) Assignee: Panasonic Intellectual Property Management Co., Ltd., Osaka-shi, Osaka (JP)

(21) Appl. No.: 16/481,280

(22) PCT Filed: Jan. 17, 2018
(86) PCT No.: PCT/JP2018/001109

§ 371 Date: Jul. 26, 2019

(30) Foreign Application Priority Data
Jan. 31, 2017 (JP) 2017-015654

(51) Int. Cl. H01M 10/04; H01M 10/0569; H01M 2/26; H01M 2/14

(52) U.S. Cl. CPC H01M 10/0468; H01M 10/0422; H01M 2/145; H01M 2/26; H01M 10/0569

(57) ABSTRACT

A nonaqueous electrolyte secondary battery includes: an electrode body; a nonaqueous electrolyte liquid; a metal-made exterior package receiving the electrode body and the nonaqueous electrolyte liquid; and a pressing member provided between the electrode body and the exterior package. An outer circumference surface of the electrode body includes an exposing section to which a surface of a negative electrode collector forming the negative electrode is exposed. In addition, the pressing member expands when absorbing the nonaqueous electrolyte liquid and presses the exposing section of the electrode body to an inner surface of the exterior package.

### TECHNICAL FIELD

The present disclosure relates to a secondary battery.

### BACKGROUND ART

PTLs 1 and 2 have disclosed a secondary battery having the structure in which an outer circumference surface of a winding type electrode body includes an exposing section to which a surface of a negative electrode collector is exposed and in which the exposing section is in contact with an inner surface of a metal-made exterior package functioning as a negative electrode terminal. In the case described above, since a negative electrode lead is not required to be fitted to an outside of the electrode body, the capacity of the battery can be increased by increasing the volume of the electrode body.

### CITATION LIST

### Patent Literature

PTL 1: Japanese Published Unexamined Patent Application No. 62-82646

PTL 2: International Publication No. 2012/042830

### SUMMARY OF INVENTION

However, according to the batteries of PTLs 1 and 2 each having the structure described above, it is not easy to maintain a preferable contact state between the outer circumference surface of the electrode body and the inner surface of the exterior package, and hence, a problem in that an electricity collection property is degraded and an internal resistance is increased may arise. In addition, the variation in internal resistance is also increased. According to the battery disclosed in PTL 2, although the negative electrode lead is provided at an inner side of the electrode body in order to suppress the increase in internal resistance, in view of the suppression of variation in internal resistance, the increase in capacity, and the like, the battery described above is still required to be improved.

A secondary battery according to one aspect of the present disclosure comprises: a positive electrode containing a positive electrode collector and a positive electrode active material layer formed on the collector; a negative electrode containing a negative electrode collector and a negative electrode active material layer formed on the collector; and at least one separator. In addition, the secondary battery described above comprises an electrode body formed by spirally winding the positive electrode and the negative electrode with the separator interposed therebetween; an electrolyte liquid; a metal-made exterior package receiving the electrode body and the electrolyte liquid; and a pressing member provided between the electrode body and the exterior package or in the electrode body. An outer circumference surface of the electrode body includes an exposing section to which a surface of the positive electrode collector or the negative electrode collector is exposed, and the pressing member expands when absorbing the electrolyte liquid and presses the exposing section of the electrode body to an inner surface of the exterior package.

According to the aspect of the present disclosure, a secondary battery which has a high capacity, a low internal resistance, and a small variation thereof can be provided.

According to the secondary battery of the aspect of the present disclosure, for example, since a preferable electricity collection property can be secured without using a negative electrode lead, while the capacity of the battery is increased, the increase in internal resistance can be suppressed, and the variation in internal resistance can also be decreased.

### BRIEF DESCRIPTION OF DRAWINGS

FIG. 1 is an axially-directed cross-sectional view of a secondary battery which is one example of an embodiment.

FIG. 2 is a radius-directed cross-sectional view of the secondary battery which is one example of the embodiment.

FIG. 3 is a view showing the state of the secondary battery, which is one example of the embodiment, before an electrolyte liquid is charged.

FIG. 4 is a view showing a secondary battery which is another example of the embodiment.

### DESCRIPTION OF EMBODIMENTS

Hereinafter, one example of an embodiment will be described in detail.

Since the drawings referred to as illustrating the embodiments are schematically drawn, the dimensional ratios and the like of the constituent elements are to be judged in consideration of the following illustration. When the term “approximately” used in this specification is explained using “approximately the entire region” by way of example, this indicates not only the entire region but also a region to be substantially regarded as the entire region.

As one example of the embodiment, although a nonaqueous electrolyte secondary battery 10 which includes a nonaqueous electrolyte liquid as an electrolyte liquid and a metal-made cylindrical case as an exterior package will be described by way of example, a secondary battery of the present disclosure is not limited thereto. The secondary battery of the present disclosure may also be a secondary battery, such as a lead storage battery or a nickel hydrogen battery, using a water-based electrolyte liquid or a square battery having a square-shaped metal-made case.

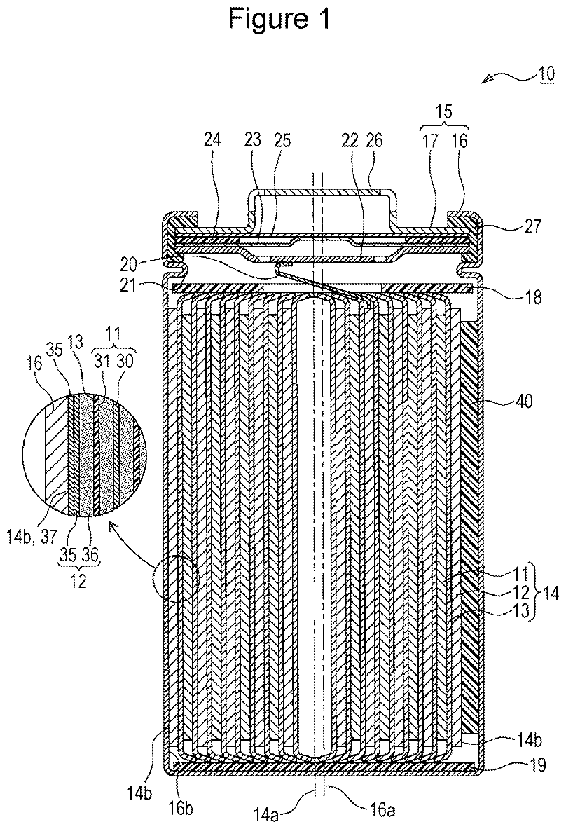

FIG. 1 is an axially-directed cross-sectional view of the nonaqueous electrolyte secondary battery 10. As shown in FIG. 1 by way of example, the nonaqueous electrolyte secondary battery 10 includes a winding type electrode body 14, a nonaqueous electrolyte liquid (not shown), and a metal-made exterior package 15 receiving the electrode body 14 and the nonaqueous electrolyte liquid. The electrode body 14 includes a positive electrode 11, a negative electrode 12, and at least one separator 13 and has a winding structure in which the positive electrode 11 and the negative electrode 12 are spirally wound with the separator 13 interposed therebetween. Hereinafter, for the convenience of illustration, one side (side from which a positive electrode lead 20 is extended) of the electrode body 14 in an axial direction is called “top”, and the other side thereof in the axial direction is called “bottom”.

The nonaqueous electrolyte liquid contains a nonaqueous solvent and an electrolyte salt dissolved in the nonaqueous solvent. As the nonaqueous solvent, for example, there may be used esters, such as ethylene carbonate (EC), dimethyl carbonate (DMC), ethyl methyl carbonate (EMC), and diethyl carbonate (DEC); ethers, such as 1,3-dioxolane; nitriles, such as acetonitrile; amides, such as dimethylformamide; and mixed solvents each containing at least two of those solvents mentioned above. The nonaqueous solvent may also contain a halogen substituent, such as fluoroethylene carbonate (FEC) or methyl fluoropropionate (FMP), in which at least one hydrogen atom in each of the solvents mentioned above is substituted by a halogen atom, such as fluorine.

The positive electrode 11, the negative electrode 12, and the separator 13, which form the electrode body 14, are each formed to have a belt shape and are spirally wound so as to be alternately laminated to each other in a radius direction of the electrode body 14. The positive electrode 11 includes a positive electrode collector 30 and positive electrode active material layers 31 formed on the positive electrode collector 30. The negative electrode 12 includes a negative electrode collector 35 and negative electrode active material layers 36 formed on the negative electrode collector 35. For the separator 13, a porous sheet having an ion permeability and an insulating property is used. In the electrode body 14, a longitudinal direction of the positive electrode 11, the negative electrode 12, and the separator 13 is a winding direction (circumference direction), and the width direction thereof is an axial direction.

In this embodiment, the negative electrode 12 forms an outer circumference surface 14b of the electrode body 14. In addition, the outer circumference surface 14b of the electrode body 14 includes an exposing section 37 to which a surface of the negative electrode collector 35 is exposed. Although described later in detail, the exposing section 37 of the electrode body 14 is pressed by a pressing member 40 to an inner surface of the exterior package 15 functioning as a negative electrode terminal.

A positive electrode lead 20 is fitted to the electrode body 14 for connection between the positive electrode 11 and a positive electrode terminal. The positive electrode lead 20 is bonded, for example, to a central portion of the positive electrode collector 30 in a longitudinal direction and is extended from a top end of the electrode body 14. The thickness of the positive electrode lead 20 is, for example, 3 to 30 times the thickness of the positive electrode collector 30 and is, in general, 100 to 300 μm.

On the other hand, the electrode body 14 preferably has no negative electrode lead. Since the surface (exposing section 37) of the negative electrode collector 35 is strongly brought into contact with the inner surface of the exterior package 15 by the pressing member 40, a preferable electricity collection property between the negative electrode 12 and the negative electrode terminal can be secured without using the negative electrode lead. Since no negative electrode lead is used, the volume of the electrode body 14 can be increased, for example, by the volume corresponding to the thickness of the lead, and hence, the capacity of the battery can be increased.

As described above, the positive electrode 11 is formed of the positive electrode collector 30 and the positive electrode active material layers 31. The positive electrode active material layer 31 is formed over the entire region of each of two surfaces of the positive electrode collector 30 formed, for example, of metal foil containing aluminum as a primary component other than a portion to which the positive electrode lead 20 is bonded. The positive electrode active material layer 31 preferably contains a positive electrode active material, an electrically conductive material, and a binding material. As the positive electrode active material, a lithium transition metal oxide containing a transition metal, such as Co, Mn, or Ni, may be mentioned by way of example. Although the lithium transition metal oxide is not particularly limited, a composite oxide represented by a general formula of Li₁₊ₓMO₂ (in the formula, −0.2<×≤0.2 holds, and M contains at least one of Ni, Co, Mn, and Al) is preferable.

As described above, the negative electrode 12 is formed of the negative electrode collector 35 and the negative electrode active material layers 36. The negative electrode active material layer 36 is formed over the entire region of each of two surfaces of the negative electrode collector 35 formed, for example, of metal foil containing copper as a primary component other than the exposing section 37 described above. The negative electrode active material layer 36 preferably contains a negative electrode active material and a binding material. As the negative electrode active material, any material may be used as long as being capable of reversibly occluding and releasing lithium ions, and for example, a carbon material, such as natural graphite or artificial graphite, a metal, such as Si or Sn, forming an alloy with lithium, an alloy thereof, or a composite oxide may be used.

Although the exposing section 37 may be formed as a part of the outer circumference surface 14b of the electrode body 14, the exposing section 37 is preferably formed as approximately the entire region of the outer circumference surface 14b. That is, the negative electrode active material layer 36 is preferably not formed as approximately the entire region of the outer circumference surface 14b. In this case, even when any part of the outer circumference surface 14b is brought into contact with the inner surface of the exterior package 15, the negative electrode collector 35 and the inner surface are directly brought into contact with each other. The exposing section 37 is formed, for example, to have one to two circumference lengths of the electrode body 14 from one end of the negative electrode collector 35 located at an outer part of the electrode body 14 in a longitudinal direction.

In order to prevent the precipitation of lithium, the negative electrode 12 is formed wider than the positive electrode 11. In addition, at least a part of the positive electrode 11 at which the positive electrode active material layer 31 is formed is disposed to face a portion of the electrode 12 at which the negative electrode active material layer 36 is formed with the separator 13 interposed therebetween. In the example shown in FIG. 1, at the outer part of the electrode body 14, the negative electrode collector 35 on which the negative electrode active material layer 36 is not formed is wound one time or more.

The exterior package 15 receiving the electrode body 14 and the nonaqueous electrolyte liquid is a metal-made case formed of a case main body 16 and a sealing body 17. The nonaqueous electrolyte secondary battery 10 includes insulating plates 18 and 19 provided at the top and the bottom of the electrode body 14, respectively. The positive electrode lead 20 is extended to a sealing body 17 side through a through-hole of the insulating plate 18 and is welded to a bottom surface of a filter 22 functioning as a bottom plate of the sealing body 17. In the nonaqueous electrolyte secondary battery 10, a cap 26 used as a top plate of the sealing body 17 electrically connected to the filter 22 functions as the positive electrode terminal. In addition, the case main body 16 functions as the negative electrode terminal. On an outer circumference surface of the case main body 16, an insulating film not shown may be provided.

The case main body 16 is a metal-made bottom-closed cylindrical container receiving the electrode body 14 and the nonaqueous electrolyte liquid. Between the case main body 16 and the sealing body 17, a gasket 27b is provided, so that the air tightness in the exterior package 15 is not only secured, but also the electric connection between the case main body 16 and the sealing body 17 is prevented. The case main body 16 has a protruding portion 21 which is formed, for example, by pressing a side surface portion thereof from the outside to support the sealing body 17. The protruding portion 21 is preferably formed to have an annular shape along the circumference direction of the case main body 16 so as to support the sealing body 17 by its top surface. In this embodiment, the exposing section 37 of the electrode body 14 is pressed to an inner circumference surface 16b of the case main body 16 by the pressing member 40.

The sealing body 17 has the structure in which the filter 22, a bottom valve 23, an insulating member 24, a top valve 25, and the cap 26 are laminated in this order from an electrode body 14 side. The individual members forming the sealing body 17 each have, for example, a disc shape or a ring shape and are electrically connected to each other except for the insulating member 24. The bottom valve 23 and the top valve 25 are electrically connected to each other at the respective central portions, and between the respective peripheral portions thereof, the insulating member 24 is provided. Since an air hole is provided in the bottom valve 23, when the inside pressure of the battery is increased by abnormal heat generation, the top valve 25 is expanded to a cap 26 side and is separated from the bottom valve 23, so that the electric connection therebetween is disconnected. In addition, when the inside pressure is further increased, the top valve is broken, and gases are exhausted from an opening portion of the cap 26.

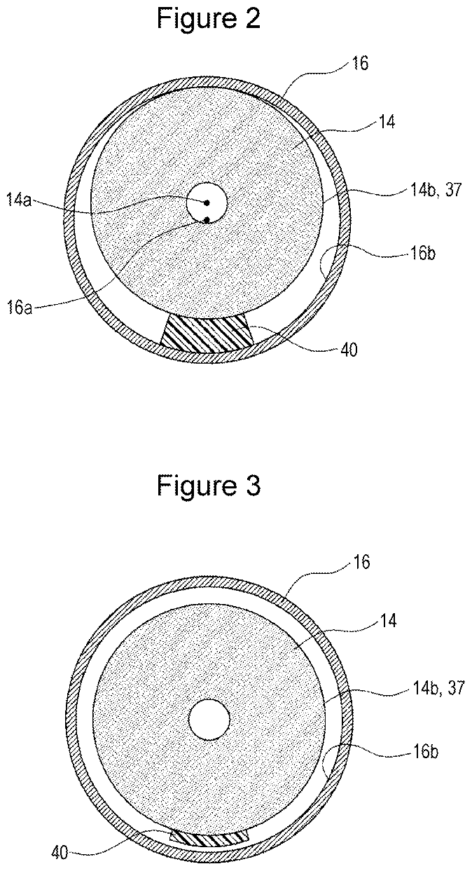

Hereinafter, with reference to FIGS. 1 to 3, the structure of the nonaqueous electrolyte secondary battery 10 and, in particular, the pressing member 40 and the structure relating thereto will be described in detail. FIG. 2 is a radius-directed cross-sectional view of the nonaqueous electrolyte secondary battery 10, and FIG. 3 is a view showing the state before the electrolyte liquid is charged.

As shown in FIGS. 1 and 2 by way of example, the nonaqueous electrolyte secondary battery 10 includes the pressing member 40 provided between the electrode body 14 and the case main body 16 of the exterior package 15. The pressing member 40 has a function to expand when absorbing the electrolyte liquid so as to press the exposing section 37 of the negative electrode collector 35 formed as the outer circumference surface 14b of the electrode body 14 to the inner circumference surface 16b of the case main body 16 functioning as the negative electrode terminal. In this embodiment, the pressing member 40 is strongly brought into contact with the outer circumference surface 14b of the electrode body 14 and the inner circumference surface 16b of the case main body 16. Since the electrode body 14 is pressed using the pressing member 40, the exposing section 37 and the inner circumference surface 16b of the case main body 16 are strongly brought into contact with each other, so that a preferable electricity collection property can be secured without using the negative electrode lead.

As shown in FIG. 3 by way of example, in a manufacturing process of the nonaqueous electrolyte secondary battery 10, for example, the electrode body 14 having the outer circumference surface 14b to which the pressing member 40 is adhered is inserted in the case main body 16. In this step, the pressing member 40 is in the state before adsorbing the nonaqueous electrolyte liquid, and the diameter of the electrode body 14 at a portion to which the pressing member 40 is adhered is smaller than the inner diameter of the case main body 16. The nonaqueous electrolyte liquid is charged in the case main body 16 in which the electrode body 14 is received. Accordingly, the pressing member 40 expands when absorbing the nonaqueous electrolyte liquid and then presses the exposing section 37 to the inner circumference surface 16b of the case main body 16. As described above, since the pressing member 40 expands when absorbing the nonaqueous electrolyte liquid, while the electrode body 14 can be smoothly inserted into the case main body 16, the preferable electricity collection property described above can be secured.

The pressing member 40 is a tape provided, for example, between the electrode body 14 and the case main body 16 and is preferably a tape to be adhered to the outer circumference surface 14b of the electrode body 14 or the inner circumference surface 16b of the case main body 16. This tape is preferably formed of a tape base material which expands when absorbing the electrolyte liquid and an adhesive layer formed on at least one surface of the tape base material. In addition, the pressing member 40 is not limited to the tape and, for example, may be a coating film, an adhesive, or the like to be applied to the outer circumference surface 14b of the electrode body 14 or the inner circumference surface 16b of the case main body 16.

The tape base material is a resin-made sheet having a thickness of, for example, 30 to 50 μm and is preferably formed using a resin having a high affinity to the nonaqueous electrolyte liquid as a primary component. As a preferable resin, for example, there may be mentioned a polystyrene, a copolymer of styrene and an α-olefin, or a fluorine resin, such as a poly(vinylidene fluoride) (PVdF). The tape base material may be a porous sheet or a foam sheet, each of which has many pores, so that the nonaqueous electrolyte liquid is likely to be permeated.

The adhesive layer described above is a layer to impart to the pressing member 40 an adhesive property to the electrode body 14 or the like. The adhesive layer is formed, for example, by applying an adhesive on one surface of the tape base material. The thickness of the adhesive layer is, for example, 5 to 30 μm. The adhesive layer is preferably formed using an adhesive (resin) excellent in electrolyte liquid resistance as a primary component. Although the adhesive may be either a hot-melt type exhibiting an adhesive property by heating or a thermosetting type to be cured by heating, in view of the productivity and the like, an adhesive having an adhesive property at room temperature is preferable. The adhesive layer is formed, for example, of an acrylic-based adhesive or a rubber-based adhesive.

Although a plurality of pressing members 40 may also be provided, the pressing members 40 are preferably localized at one side of the electrode body 14 in the radius direction. In this embodiment, one pressing member 40 is adhered to the outer circumference surface 14b of the electrode body 14. In addition, a portion of the exposing section 37 of the outer circumference surface 14b of the electrode body 14 located at a side of the electrode body 14 opposite to the pressing member 40 in the radius direction is pressed to the inner circumference surface 16b of the case main body 16. That is, the portion of the outer circumference surface 14b to which the pressing member 40 is adhered and the portion of the outer circumference surface 14b in contact with the inner circumference surface 16b are aligned in the radius direction of the electrode body 14. In this case, along the cross-section of the electrode body 14 in the radius direction, two points of the exposing section 37 and the pressing member 40 are in contact with the inner circumference surface 16b of the case main body 16.

According to a related general nonaqueous electrolyte secondary battery, a central axis 14a of the electrode body 14 and a central axis 16a of the case main body 16 approximately coincide with each other. On the other hand, in the nonaqueous electrolyte secondary battery 10, as shown in FIG. 2, since the electrode body 14 is pressed by the pressing member 40 to one side in the radius direction, the central axes 14a and 16a thereof do not coincide with each other. The electrode body 14 is received in the case main body 16 in the state in which the central axis 14a is shifted from the central axis 16a of the case main body 16.

The pressing member 40 has, for example, a long belt shape in an axial direction of the electrode body 14. The length of the pressing member 40 preferably corresponds to 50% or more of the length of the electrode body 14 in the axial direction, and the pressing member 40 may be bonded to the approximately entire length of the electrode body 14 in the axial direction.

When tapes maintaining the electrode structure are adhered to two end portion of the electrode body 14 in the axial direction, the pressing member 40 may be bonded so as to be overlapped with at least one of the tapes or so as not to be overlapped therewith. In addition, when a tape maintaining the electrode structure is adhered to a central portion of the electrode body 14 in the axial direction, the pressing member 40 may be bonded so as to be overlapped with the tape or so as not to be overlapped therewith.

Furthermore, when a tape maintaining the electrode structure is adhered to one end portion of the outermost circumference of the electrode body 14, the pressing member 40 may be bonded so as to be overlapped with the tape or so as not to be overlapped therewith. However, when the pressing member 40 is adhered so as not to be overlapped with the tape, the pressing member 40 is preferably adhered so as not to be intersected with an extended line formed between the central axis 14a of the electrode body 14 and the periphery of the tape.

The width of the pressing member 40 is, for example, approximately constant and is set to 3% to 30% of the circumference length of the electrode body 14. Although being changed depending on the diameter of the electrode body 14 or the like, a preferable range of the width of the pressing member 40 is, for example, 5 to 30 mm. Although the thickness of the pressing member 40 is not particularly limited, in the state before the electrolyte liquid is absorbed, for example, the thickness described above is 35 to 80 μm and preferably 50 to 60 μm. Even when the pressing member 40 is fitted to the electrode body 14, the thickness of the pressing member before liquid absorbing is preferably less than the difference in diameter between the battery case and the electrode body 14 (in the case of a cylindrical battery). The reason for this is that when the electrode body 14 is inserted in the battery case, the battery case is prevented from being brought into contact with the electrode body 14 and the pressing member 40. The pressing member 40 preferably expands when absorbing the electrolyte liquid so as to have a thickness larger than the difference in diameter between the battery case and the electrode body 14. The reason for this is to stabilize the electric connection between the negative electrode 12 and the battery case.

When absorbing the nonaqueous electrolyte liquid, the pressing member 40 preferably expands so that the thickness thereof is increased twice or more. The rate of change in thickness of the pressing member 40 by liquid absorption is preferably 2 to 3 times and more preferably 2.4 to 2.7 times. The rate of change in thickness of the pressing member 40 is calculated by dividing the thickness obtained after the pressing member 40 is dipped in the nonaqueous electrolyte liquid for 3 minutes by the thickness obtained before the pressing member 40 is dipped in the nonaqueous electrolyte liquid. The thickness of the pressing member 40 is measured by a film thickness meter. The thickness of the pressing member 40 is, for example, 50 to 60 μm before absorption of the electrolyte liquid and is 130 to 150 μm after liquid absorption. In addition, the thickness after liquid absorption is not measured in the state in which the pressing member 40 is received in the battery case but is measured outside of the case after the pressing member 40 is dipped in the electrolyte liquid.

Before and after the absorption of the nonaqueous electrolyte liquid, the changes in length and width of the pressing member 40 are preferably small, and only the thickness thereof is preferably significantly changed. The rates of the changes in width and length of the pressing member 40 are each, for example, preferably less than 1.5 times and more preferably less than 1.2 times. The rate of change in thickness of the pressing member 40 is preferably 2 times or more. Since the thickness of the pressing member 40 is only significantly changed by the absorption of the nonaqueous electrolyte liquid, the electrode body 14 can be efficiently pressed.

The pressing member 40 may also contain an electrically conductive material. The pressing member 40 may contain, for example, an electrically conductive filler formed of fine particles of a metal or carbon or may have an electrically conductive layer formed of a thin film, such as a metal layer or a carbon layer, on the surface of the tape base material. When the structure in which the outer circumference surface 14b of the electrode body 14 and the inner circumference surface 16b of the case main body 16 are electrically connected to each other with the electrically conductive material described above interposed therebetween is formed, the electricity collection property may be further improved.

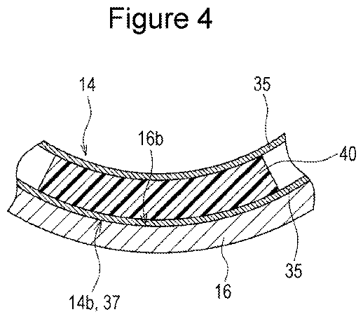

FIG. 4 is a view showing another example of the embodiment. Since the pressing member 40 is provided in the electrode body 14, the embodiment shown in FIG. 4 by way of example is different from the above-described embodiment in which the pressing member 40 is provided between the electrode body 14 and the exterior package 15. The pressing member 40 is present between parts of the negative electrode 12 located at, for example, the outer part of the electrode body 14. In addition, of the exposing section 37 of the electrode body 14, a portion located between the pressing member 40 and the inner circumference surface 16b of the case main body 16 is pressed to the inner circumference surface 16b. That is, the pressing member 40 presses a portion of the negative electrode collector 35 which forms the outer circumference surface 14b to the inner circumference surface 16b of the case main body 16 from the inside of the electrode body 14. In this case, the portion of the exposing section 37 located at a side of the electrode body 14 opposite to the pressing member 40 in the radius direction is also preferably pressed to the inner circumference surface 16b of the case main body 16. In this case, along the cross-section of the electrode body 14 in the radius direction, two points on the surface of the exposing section 37 are in contact with the inner circumference surface 16b of the case main body 16.

In addition, in the embodiment described above, although the exterior package 15 functions as the negative electrode terminal, the exterior package 15 may function as the positive electrode terminal. In this case, the surface of the positive electrode collector 30 is exposed to the outer circumference surface 14b of the electrode body 14, and the pressing member 40 presses the exposing section to which the surface of the positive electrode collector 30 is exposed to the inner surface of the exterior package 15.

### EXAMPLES

Hereinafter, although the present disclosure will be further described with reference to Examples, the present disclosure is not limited to the following Examples.

### Example 1

[Formation of Positive Electrode]

After 100 parts by mass of a lithium transition metal oxide represented by LiNi_{0.88}Co_{0.09}Al_{0.03}O₂, 1 part by mass of acetylene black, and 1 part by mass of a poly(vinylidene fluoride) were mixed together, an appropriate amount of N-methyl-2-pyrrolidone (NMP) was further added, so that a positive electrode mixture slurry was prepared. Next, this positive electrode mixture slurry was applied to two surfaces of a positive electrode collector formed of aluminum foil, and coating films thus formed were dried. After the collector on which the coating films were formed was compressed using a roller machine, the collector was cut into a predetermined electrode size, so that a positive electrode in which positive electrode active material layers were formed on the two surfaces of the positive electrode collector was formed. The size of the positive electrode was set so that the width and the length were 62 mm and 903 mm, respectively. In addition, at a central portion of the positive electrode in a longitudinal direction, a portion at which the surface of the collector was exposed was formed and was then welded to a positive electrode lead by ultrasonic wave welding.

[Formation of Negative Electrode]

After 100 parts by mass of graphite powder, 1 part by mass of a styrene-butadiene rubber (SBR), and 1 part by mass of a carboxymethyl cellulose were mixed together, an appropriate amount of water was further added, so that a negative electrode mixture slurry was prepared. Next, this negative electrode mixture slurry was applied to two surfaces of a negative electrode collector formed of copper foil, and coating films thus formed were dried. After the collector on which the coating films were formed was compressed using a roller machine, the collector was cut into a predetermined electrode size, so that a negative electrode in which negative electrode active material layers were formed on the two surfaces of the negative electrode collector was formed. The size of the negative electrode was set so that the width and the length were 64 mm and 982 mm, respectively. In addition, in a region having a length of 23 mm from one end of the negative electrode in a longitudinal direction, an exposing section to which the surface of the collector was exposed was formed.

[Preparation of Nonaqueous Electrolyte Liquid]

Ethylene carbonate (EC) and ethyl methyl carbonate (EMC were mixed together at a volume ratio of 3:7. In this mixed solvent, liPF₆ was dissolved at a concentration of 1 mol/L, so that a nonaqueous electrolyte liquid was prepared.

[Formation of Battery]

The positive electrode and the negative electrode were spirally wound with at least one polyethylene-made separator interposed therebetween, so that a winding type electrode body was formed. In this case, the electrodes and the separator were wound so that the positive electrode active material layer faced the negative electrode active material layer with the separator interposed therebetween and so that the exposing section of the negative electrode formed an outer circumference surface of the electrode body. The entire outer circumference surface of the electrode body was an exposing section to which the surface of the negative electrode collector was exposed. In addition, to two end portions of the electrode body in an axial direction, tapes were adhered so as to maintain the winding structure of the electrode body.

Next, a belt-shaped pressing member was adhered to the outer circumference surface of the electrode body. For the pressing member, an adhesive tape formed of a tape base material containing a polystyrene as a primary component and an adhesive layer containing an acrylic resin as a primary component was used. The adhesive tape had a width of 10 mm, a length of 60 mm, and a thickness of 55 μm and was adhered to a region along the axial direction so as not to be overlapped with the tapes maintaining the winding structure of the electrode body. The coefficient of volume expansion of the adhesive tape was 2.7 times (the rate of increase in thickness was approximately 2.7 times) under the conditions in which the adhesive tape was dipped in the above nonaqueous electrolyte liquid for 1 minute).

After the electrode body provided with the above adhesive tape was received in a metal-made bottom-closed cylindrical case main body (outer diameter: 21 mm, and height: 70 mm), a top end portion of the positive electrode lead was welded to a filter of a sealing body by ultrasonic wave welding. In addition, the nonaqueous electrolyte liquid was charged in the case main body, and an opening portion of the case main body was sealed by the sealing body, so that a cylindrical battery was formed. When the nonaqueous electrolyte liquid was charged, since the pressing member expanded, the thickness thereof was increased, and the pressing member was strongly brought into contact with an inner circumference surface of the case main body to press the electrode body, so that a portion of the outer circumference surface (exposing section of the negative electrode) of the electrode body located at a side opposite to the pressing member in a radius direction was strongly pressed to the inner circumference surface of the case main body. The electrode body was received in the case main body in the state in which the central axis thereof was shifted from the central axis of the case main body.

### Comparative Example 1

Except for that a positive electrode having a length of 872 mm and a negative electrode having a length of 951 mm were used, an exposing section to which a surface of a negative electrode collector was exposed was formed as a part of an outer circumference surface of an electrode body, and a negative electrode lead to be welded to an inner surface of a bottom portion of a case main body was welded to the exposing section described above, a cylindrical battery was formed in a manner similar to that of Example 1. The exposing section of Comparative Example 1 was provided in a range having a length of 23 mm from one end of the negative electrode in a longitudinal direction. The thickness of the negative electrode lead was 100 m. When the thickness of the negative electrode lead was 60 μm, the electric resistance thereof was high as compared to that of a negative electrode lead having a thickness of 100 m, and charge/discharge may not be performed at a predetermined current in some cases.

### Comparative Example 2

Except for that the pressing member was not used, a cylindrical battery was formed in a manner similar to that of Example 1.

Performance evaluation of the secondary battery of each of Example and Comparative Examples was performed by the following method, and evaluation results are shown in Table 1.

[Measurement of Resistance Value (Evaluation of Internal Resistance)]

In a temperature environment at 25° C., the battery was charged at a constant current of 0.3 It until the battery voltage reached 3.7 V and was then charged at a constant voltage. Subsequently, by the use of a low resistance meter (alternating current four terminal method at a measurement frequency of 1 kHz), an inter-terminal resistance of the battery was measured, and the resistance value thus measured was regarded as the internal resistance of the battery. The measurement of the resistance value was performed twice on each battery, and the ratio (resistance ratio) of the average resistance value and the ratio (range ratio) of the difference between the maximum resistance value and the minimum resistance value of the battery were obtained. The resistance ratio and the range ratio shown in Table 1 were the ratios obtained when the average resistance value and the difference between the maximum resistance value and the minimum resistance value of the battery of Example 1 were each regarded as 100%.

[Measurement of Discharge Capacity (Evaluation of Battery Capacity)]

In a temperature environment at 25° C., charge was performed at a constant current of 0.2 It until the batter voltage reached 4.2 V. After one-minute rest was taken, discharge was performed at a constant current of 0.2 It until the battery voltage reached 2.5 V, and the discharge capacity in this case was obtained. The capacity ratio shown in Table 1 is the ratio obtained when the discharge capacity of the battery of Example 1 was regarded as 100%.

TABLE 1

| | NEGA- | | | | |
|---|---|---|---|---|---|
| | TIVE | | | | |
| | ELEC- | PRESS- | RESIS- | | CAPAC- |
| | TRODE | ING | TANCE | RANGE | ITY |
| | LEAD | MEMBER | RATIO | RATIO | RATIO |
| EXAMPLE 1 | NO | YES | 100% | 100% | 100% |
| COMPARA- | YES | NO | 103% | 100% | 98.2% |
| TIVE EX- | | | | | |
| AMPLE 1 | | | | | |
| COMPARA- | NO | NO | 103% | 700% | 99.8% |
| TIVE EX- | | | | | |
| AMPLE 2 | | | | | |

As shown in Table 1, compared to the battery of Comparative Example 2, the battery of Example 1 had a low resistance value and a small variation thereof and also had a high capacity. According to the battery of Comparative Example 1, although it was difficult to maintain a preferable contact state between the exposing section of the electrode body and an inner surface of the exterior package, according to the battery of Example 1, since the electrode body was pressed using the pressing member, the exposing section of the electrode body and the inner circumference surface of the case main body were strongly brought into contact with each other, and hence, a preferable electricity collection property can be secured. In addition, the battery of Example 1 had a low resistance value as compared to that of the Comparative Example 1 in which the negative electrode lead was used. Since the battery of Example 1 used no negative electrode lead, the capacity thereof was high as compared to that of the battery of Comparative Example 1. By the difference in thickness between the negative electrode lead of Comparative Example 1 and the pressing member of Example 1, in the battery of Example 1, the diameter of the electrode body in the radius direction can be increased. That is, compared to the battery of Comparative Example 1, by the battery of Example 1, the sizes of the positive electrode and the negative electrode can be increased, and hence, the capacity can be increased as compared to that of the battery of Comparative Example 1.

### REFERENCE SIGNS LIST

10 nonaqueous electrolyte secondary battery
11 positive electrode
12 negative electrode
13 separator
14 electrode body
14a central axis
14b outer circumference surface
15 exterior package
16 case main body
16a central axis
16b inner circumference surface
17 sealing body
18, 19 insulating plate
20 positive electrode lead
21 protruding portion
22 filter
23 bottom valve
24 insulating member
25 top valve
26 cap
27 gasket
30 positive electrode collector
31 positive electrode active material layer
35 negative electrode collector
36 negative electrode active material layer
37 exposing section
40 pressing member

1. A secondary battery comprising:
an electrode body which includes a positive electrode containing a positive electrode collector and a positive electrode active material layer formed on the collector; a negative electrode containing a negative electrode collector and a negative electrode active material layer formed on the collector; and a separator, and which is formed by spirally winding the positive electrode and the negative electrode with the separator interposed therebetween;
an electrolyte liquid;
a metal-made exterior package receiving the electrode body and the electrolyte liquid; and
a pressing member provided between the electrode body and the exterior package or in the electrode body,
wherein an outer circumference surface of the electrode body includes an exposing section to which a surface of the positive electrode collector or the negative electrode collector is exposed, and
the pressing member expands when absorbing the electrolyte liquid so as to press the exposing section of the electrode body to an inner surface of the exterior package.

2. The secondary battery according to claim 1,
wherein the surface of the negative electrode collector is exposed to the outer circumference surface of the electrode body, and
the pressing member presses the surface of the negative electrode collector to the inner surface of the exterior package.

3. The secondary battery according to claim 1,
wherein the pressing member is a tape formed of a tape base material which expands when absorbing the electrolyte liquid and an adhesive layer formed on at least one surface of the tape base material.

4. The secondary battery according to claim 1,
wherein the exposing section of the electrode body located at a side opposite to the pressing member in a radius direction is pressed to the inner surface of the exterior package.

5. The secondary battery according to claim 4,
wherein the exterior package has a bottom-closed cylindrical shape, and
the electrode body is received in the exterior package so that a central axis of the electrode body is shifted from a central axis of the exterior package.

6. The secondary battery according to claim 1,
wherein the pressing member is provided in the electrode body, and
a portion of the exposing section of the electrode body located between the pressing member and the inner surface of the exterior package is pressed to the inner surface thereof.

7. The secondary battery according to claim 1,
wherein the pressing member contains an electrically conductive material and is in contact with the exposing section of the electrode body and the inner surface of the exterior package.

8. The secondary battery according to claim 1,
wherein along a cross-section of the electrode body in a radius direction, the exposing section and the pressing member or two points on the surface of the exposing section are in contact with the inner surface of the exterior package.
